(19) United States
(12) Patent Application Publication
(10) Pub. No.: US 2011/0283594 A1
(43) Pub. Date: Nov. 24, 2011

(54) AUTOMATIC CASTING REEL

(75) Inventor: Philippe BOY, Biganos (FR)

(73) Assignee: DECATHLON, Villeneuve D'Ascq (FR)

(21) Appl. No.: 13/108,722

(22) Filed: May 16, 2011

(30) Foreign Application Priority Data
May 19, 2010 (FR) 10/53870

(51) Int. Cl. A01K 91/02; A01K 87/00; A01K 89/02

(52) U.S. Cl. 43/25

(57) ABSTRACT

The invention relates to a casting fishing rod including a reel on which is wound some fishing line. The reel includes a fishing line braking system which can be positioned in a line braking or non-braking position. A pusher element is configured, in a first position, to activate the braking system in the braking position and, in a second position, to allow the braking system to return to the non-braking position. A stop system is configured, in a position of engagement, to hold the pusher element in the first position and, in a position of disengagement, to release the pusher element and allow it to return to the second position. An inertia flyweight is attached to a flexible wire element arranged between the stop system and the rod, the inertia of the flyweight allowing movement of the stop system into the position of disengagement.

The present invention relates to a casting rod having the essential objective of being easily usable by any type of fisherman, from a beginning fisherman to an experienced fisherman.

Traditionally, a casting rod is made up of a proper fishing rod, well known to the person skilled in the art, and of a fishing reel on which is wound the fishing line, which can either be unreeled during casting in order to project the bait a certain distance into the fishing pond or reeled in through the operation of a crank in order to retrieve the bait or a fish caught by using the bait.

“Spinning” type and “closed face” type fishing reels are distinguished.

“Spinning” reels include a pickup which, in a first unlatched position, allows the fishing line wound around a fixed spool in the reel to unreel and, in a second latched position, allows the line to be reeled in around the fixed spool through the operation of the crank.

“Closed face” reels include in particular a nosecone, a cup housed within the nosecone and a trigger. Operating the trigger allows, through a mechanism, translation of the cup which comes into contact with the inside of the nosecone, which brakes the fishing line caught between the cup and the nosecone. Conversely, releasing the trigger allows it to return to its normal position, thereby disengaging the cup from the nosecone, which releases the fishing line and either allows said fishing line to reel out or conversely allows the fishing line to be reeled in when the crank is operated.

Thus, with a “spinning” reel, the fisherman holds the fishing line with his finger, opens the pick up, then proceeds with casting the line by whipping the rod forward, during which step the fisherman must release the fishing line held with the finger in order to allow the line to be projected forward.

In the case of a “closed face” fishing reel, the fisherman engages the trigger, which allows the fishing line to be blocked within the reel. The fisherman then proceeds with the casting motion by whipping the fishing rod forward. During this last step, the fisherman must release the trigger, which allows its disengagement, and thus the unbraking of the line, allowing it to be projected forward, the fisherman being able to subsequently rewind the line by means of the crank in order to retrieve the line.

In these different typical cases, the major problem resides in the synchronization between the casting motion and the instant at which the fisherman will release the line in order to allow it to be properly projected, this synchronization being all the more awkward when the fisherman is a beginner.

The present invention aims to correct this major disadvantage, facilitates the use of the casting fishing rod and guarantees correct projection of the fishing line and of the bait at each casting motion. To this end, the invention applies to a casting fishing rod including a reel on which fishing line is wound. Traditionally the reel includes a line braking system configured to hold the fishing line when in a braked position, and to release the fishing line when in an unbraked position. Preferably, the design of the fishing reel is similar to that of the “closed face” reel, that is to say that this reel includes a nosecone and a cup, said cup being capable of being actuated so as to come into contact with the inside of the nosecone and to provide braking of the fishing line, or on the contrary to be disengaged from the nosecone so as to release the fishing line. Design variations can however be contemplated that operate on the same principle, such as for example a reel equipped with a pick up and a fishing line holding brake actuated by a trigger, as is known to the person skilled in the art.

Remarkably, the casting fishing [equipment] that is the object of the invention comprises:
a pusher element configured to be moved to a first position, in which said pusher element activates the braking system in its braking position, and to be moved to a second position in which said pusher element allows braking system to return to the unbraked position;
a stop system on the pusher element so configured as to, when in a position of engagement, hold the pusher element in the first position and, when in a position of disengagement, to release the pusher element so as to allow its return to the second position and;
an inertial flyweight attached to a flexible wire element, a first end whereof is secured to the fishing rod, the inertia of the flyweight allowing movement of the stop system to the position of disengagement.

Preferably, the stop system engages automatically upon actuation of the pusher element in the first position. However, manual positioning of the stop system in its position of engagement can be contemplated without departing from the scope of the invention.

It is understood that according to this design, the fisherman actuates the pusher element in its first position, which activates the braking system in the fishing line braking position. Operating the pusher element in its first position also allows engagement of the stop system which ensures that the pusher element is held in its first position, and consequently holds the braking system in the braking position. Thus, the fisherman can proceed with the casting motion by whipping the fishing rod forward. The casting motion then acts upon the flyweight; due to its inertia, it allows a tension to be exerted upon the stop system by way of the wire element so as to move it to the position of disengagement in which the pusher element is released and can return to its second position, which allows the braking system to return to the fishing line non-braking position, and consequently allows the projection of the line and the bait forward into the fishing pond. Thus it is no longer necessary to synchronize the casting motion with the instant in which the fisherman must release the fishing line so as to allow the projection of the bait into the water.

According to a first embodiment of the casting fishing rod that is the object of the present invention, the pusher element is mounted directly on the reel and provided with a head in the manner of a trigger on traditional reels. Furthermore, the stop system consists of a stop pin and an actuating pin mounted for longitudinal translation on the fishing rod, said stop pin including a rear end forming a stop on the head of the pusher element moved to its first position, and a forward end secured to a rear end of the actuating pin. This actuating pin also has a forward end secured to the first end of the flexible wire element. According to this embodiment, for example, the use of “closed end” reels can be contemplated with a trigger arranged at the forward end, which can have the advantage of being able to easily replace the reel in the event of a breakdown thereof, without replacing the rest of the casting fishing rod that is the object of the present invention.

According to this first embodiment of the casting fishing rod that is the object of the present invention, a guide member is configured to receive the stop pin and the actuating pin so that they slide along their longitudinal axes, said guide member being additionally configured to be attached to the fishing rod.

Preferably, according to this first embodiment of the casting fishing rod of the present invention, the pusher element is pivotably mounted so as to move into the first position or into the second position, the braking system of the reel being configured to reposition said pusher element into the second position when the stop system is in the position of disengagement. However, a pusher element mounted for vertical translation on the reel could be contemplated on the same principle, the lower position of the pusher element corresponding to the non-braking position of the braking system, and translation of the pusher element into the upper position corresponding to the braking position, the upper position being that in which the stop pin, when in the position of engagement, would hold the head of the pusher element.

According to a second embodiment of the casting fishing rod that is the object of the present invention, the pusher element includes an arm and a pusher finger, said arm and finger being pivotably mounted on the fishing rod. In addition, the stop system is configured to hold in the position of engagement a forward end of the arm in an upward pivoted position in which the pusher finger acts on the fishing line braking system to hold it in the braking position.

According to the invention, the stop system includes return means configured to provide movement of said stop system into the position of engagement upon movement of the pusher element into the first position. This facilitates the manipulation of the casting fishing pole when the fisherman desires to proceed with a casting motion; he only needs to actuate the pusher element in its first position, the return means effecting automatic positioning of the stop system into the position of engagement.

According to the invention, the casting fishing rod includes a tensioning system configured to alter the triggering sensitivity of the stop system under the influence of the flyweight inertia. This has the advantage of optimally adjusting the casting fishing rod to the fisherman's strength when he proceeds with a casting motion.

According to the invention, the casting fishing reel includes a compensation system configured to take up the existing play in the braking system and to guarantee the braking of the fishing line when said braking system is in the braking position and the pusher element is in the first position. Thus the fishing line remains properly braked when the pusher element is actuated, despite any play in the braking system in the reel.

According to the second embodiment of the casting fishing rod that is the object of the present invention, the compensation system is implemented between the arm and the pusher finger. For this purpose, the arm and the pusher finger are mounted so as to allow them to pivot with respect to one another, a return member being arranged between said arm and the pusher finger so as to, in the first position of the pusher element, exert a force on the pusher finger and ensure that said pusher finger activates and properly holds the fishing line braking system in the braking position.

Preferably, according to the second embodiment of the casting fishing rod that is the object of the present invention, the stop system includes a stop member configured to move rearward into a position holding the forward end of the arm arranged in an upward pivoted position, and to move forward, under the influence of the flyweight into a position disengaged from the forward end of the arm allowing the pusher element to return to the second position. In addition, a return element is configured to exert a force on the stop member so as to move said stop member rearward.

Preferably, according to this second embodiment of the casting fishing rod, the stop member is pivotably mounted with respect to the fishing rod, the return element being a spring or an elastic. Variations can however be contemplated according to this second embodiment. Thus, according to one variation, the stop member and the return member consist concomitantly of a flexible blade, a first end whereof is fixed with respect to the fishing rod and a second end whereof allows the forward end of the arm to be held in the upward pivoted position, said second end of the blade being able to bend under the influence of the inertia of the flyweight and resume its normal position when the inertia of the flyweight ceases.

According to the second embodiment of the casting fishing rod that is the object of the present invention, the arm includes at its rear end a control system configured to operate the pusher element in its first position. Such a control system facilitates the operating of the pusher element while correctly holding the casting fishing rod with the hands.

According to the invention, the casting fishing rod includes a locking/unlocking system for the stop system configured to allow manual use of the pusher element. Thus it is possible to deactivate the stop system so as to use the pusher element in the same way as a trigger like those existing on traditional “closed end” reels.

According to the invention, the casting fishing reel includes a support member configured to be attached to said fishing rod and to receive the pusher element and the stop system. This facilitates the arrangement of the pusher element and the stop system on the fishing rod.

According to the invention, the casting fishing rod includes a holding member configured to be attached to the fishing rod, attachment means being arranged between the forward end of the flexible wire element and said holding member. This has the advantage of facilitating the installation or the removal of the flexible wire element with the object of facilitating its replacement in the event of a fault, or for changing the flyweight.

According to the invention, the flexible wire element is made of an injection molded material. Variations can however be contemplated, such as textile materials for example.

The features and advantages of the present invention will become apparent upon reading the following description of two preferred embodiments of the casting fishing rod, which rely on figures among which:

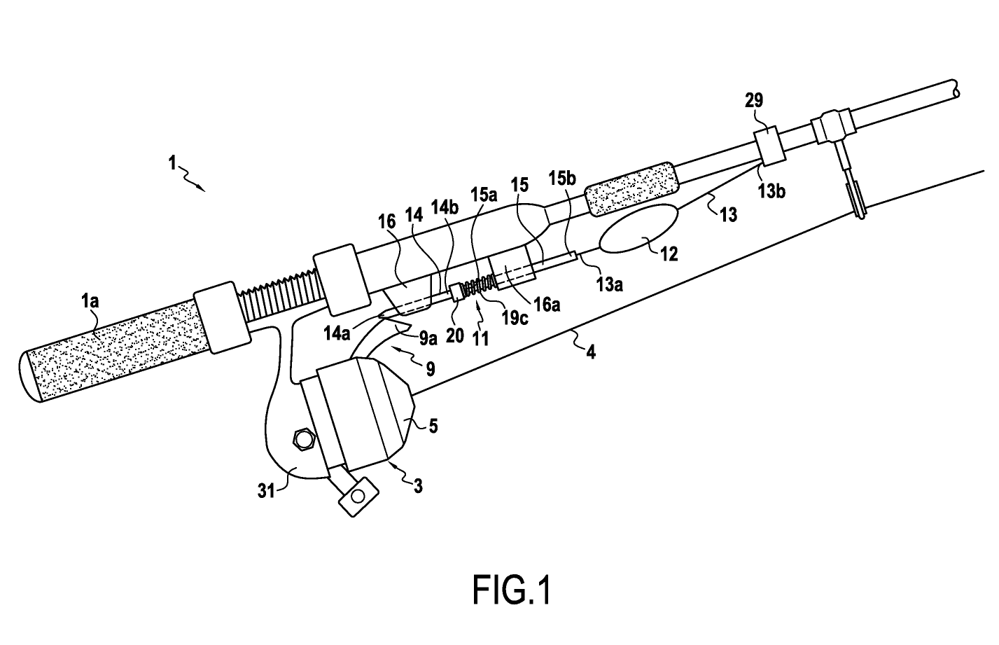

FIG. 1 illustrates a first embodiment of the casting fishing rod that is the object of the present invention;

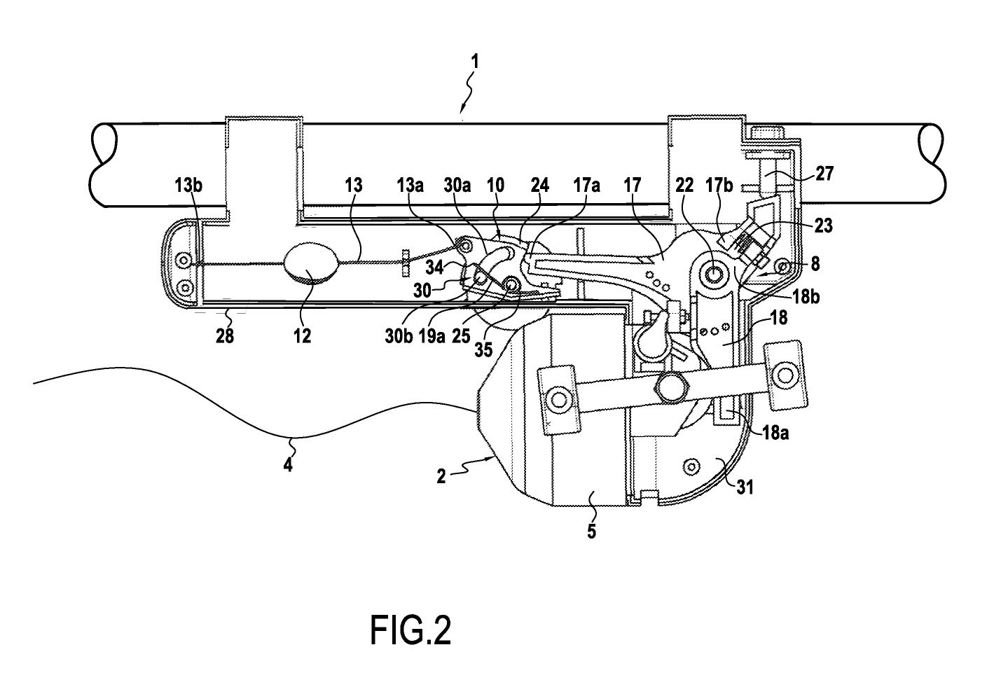

FIG. 2 illustrates a second embodiment of the casting fishing rod highlighting a first implementation of return means for the stop system;

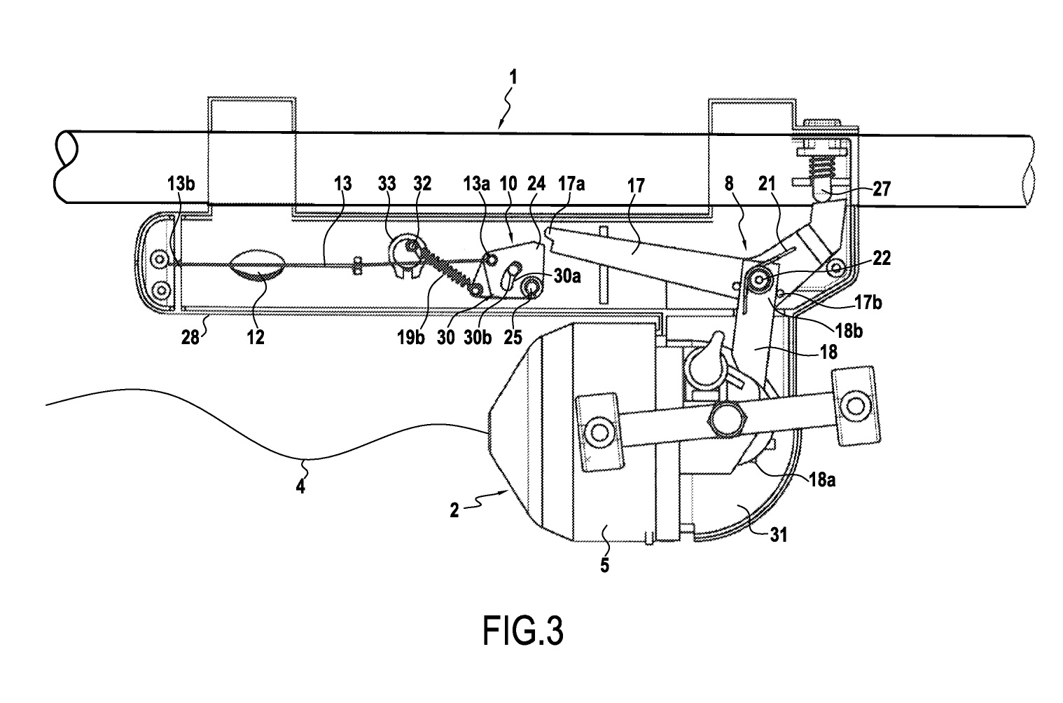

FIG. 3 illustrates a second embodiment of the fishing rod, similar to that of FIG. 2, highlighting a variation in implementing return means for the stop system;

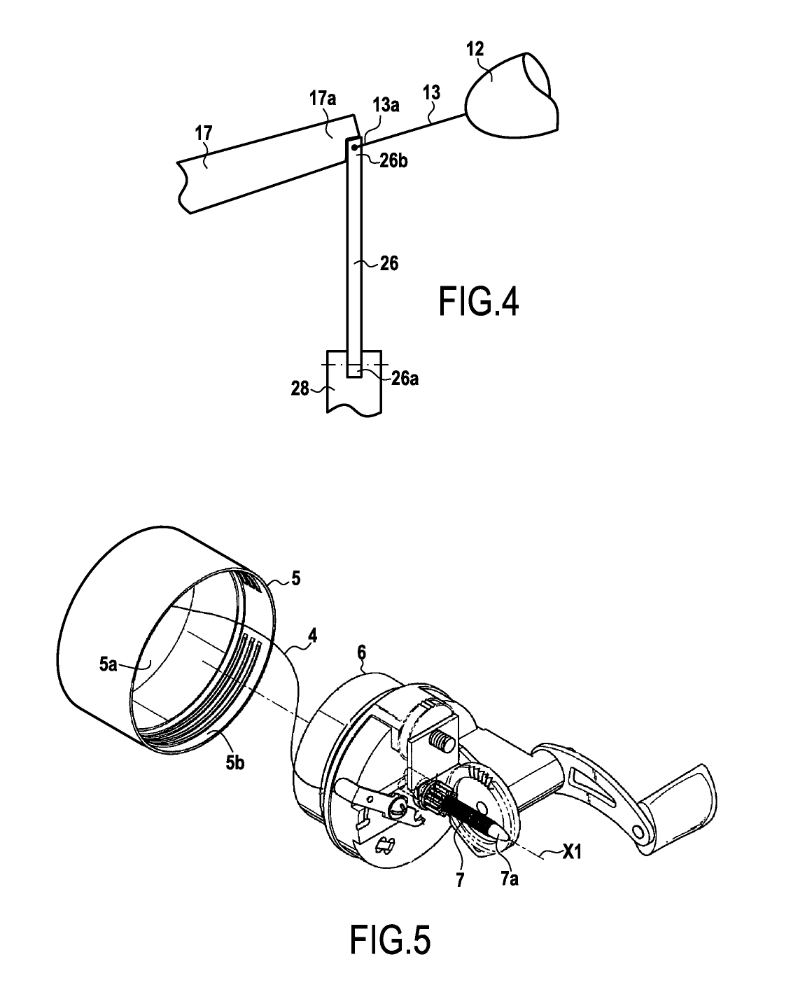

FIG. 4 illustrates a design variation in the stop system and return means according to the second embodiment of the casting fishing rod illustrated in FIGS. 2 and 3;

FIG. 5 illustrates an embodiment of the reel highlighting the fishing line braking system.

FIGS. 1 through 3 illustrate the casting fishing rod that is the object of the present invention, and more particularly the proximal portion of said casting fishing rod which the fisherman is holding with his hands during the practice of fishing and where the fishing reel 2, 3 is set.

According to the invention, the casting fishing rod 1 includes a reel 2, 3 on which is wound some fishing line 4, said reel including a fishing line 4 braking system. This braking system, illustrated in FIG. 5, consists in particular of a nosecone 5 into which part of the reel mechanism and the spool on which the line 4 is wound are incorporated. This drum is covered by a cup 6 which is housed within the nosecone 5 and has a shape similar to that of said nosecone 5. This cup 6 is capable of translating longitudinally along axis X1, illustrated in FIG. 5. When the cup 6 is translated forward, it comes into contact with the underside 5a of the nosecone 5 through which the fishing line 4 passes, as illustrated in FIG. 5, which makes it possible, by putting the cup 6 in contact with the underside 5a of the nosecone 5, to provide braking of the fishing line 4. Conversely, when the cup 6 returns to its normal rearward translated position as shown in FIG. 5, it is disengaged from the underside 5a of the nosecone 5, which either allows the line to reel out due to a casting motion or allows it to be reeled in around the spool by operating on the crank of the reel 2, 3. Of course, as illustrated in FIG. 1 through 3, the reel 2, 3 includes a matching housing 31 on its rearward portion, the nosecone 5 including for example a female thread 5b illustrated in FIG. 5 allowing it to be screwed onto the housing 31 as illustrated in FIGS. 1 through 3.

The translation of the cup 6 is, for example, provided by means of a translation pin 7 built into said cup 6. Pressure exerted on the end 7a of this pin 7 allows it to translate forward, which causes the cup 6 to move forward. This translation pin 7 is mounted with a spring return making it possible to ensure its return to the rearward position when the pressure on its end 7a ceases, and hence the rearward translation of the cup 6 to its normal position illustrated in FIG. 5. Of course, variations in the braking system having a similar function can be contemplated on the reel.

The braking system of the reel 2, 3 is operated by means of a pusher element 8, 9 illustrated in FIGS. 1 through 3, bearing for example on the rear end 7a of the translation pin 7.

On the embodiment illustrated in FIG. 1, the pusher element 9 is mounted directly on the reel 3, which has the advantage of being able to use traditional reels having this type of configuration. This pusher element 9 is provided with a head 9a illustrated in FIG. 1. This pusher element 9 is mounted pivotably on the reel 3 and is connected with the translation pin, for example at its rear end 7a on which the pusher element 9 bears. When the pusher element 9 is pivoted forward as illustrated in FIG. 1, the cup 6 is disengaged from the nosecone 5 which leaves the fishing line free to reel out or to be reeled in. Conversely, when the pusher element 9 is pivoted rearward, it operates the translation pin 7 forward and allows the cup 6 to come into contact with the underside 5a of the nosecone 5, effecting the braking of the fishing line 4. Of course, design variations of the pusher element can be contemplated, providing for example a pusher element 9 mounted for vertical translation, a lower position of the pusher element corresponding to a position where the fishing line 4 is unbraked and a higher position of the pusher element corresponding to a position where the fishing line is braked. In such a case, a supplementary transmission member will be contemplated for example between the translation pin 7 and the pusher element 9.

The presence of a stop system 11 is observable in FIG. 1. This stop system 11 consists of a stop pin 14 with an operating pin 15 extending forward. In FIG. 1 the stop pin 14 and the operating pin 15 are arranged along one and the same longitudinal axis. However, arranging them along two parallel longitudinal axes could be contemplated. The stop pin 14 has its rear end 14a abutting a head 9a configured on the top end of the pusher element 9. The forward end 14b of the stop pin 14 is integral with the rear end 15a of the operating pin 15. In addition, these two pins, stop pin 14 and operating pin 15, are mounted for longitudinal translation on a guide member 16 affixed to the handle of the fishing rod 1. This guide member 16 can be attached to the handle 1a of the casting fishing rod 1 by clamping ring systems or the equivalent. Furthermore, a permanent attachment or a detachable mounting can be contemplated.

It can be noted in FIG. 1 that the front end 15b of the operating pin 15 is affixed to the rear end 13a of a flexible wire element 13, the front end 13b whereof is affixed to the casting fishing rod 1 by means of a connecting member 29. In addition, a flyweight 12 is mounted on this flexible wire element 13 as illustrated in FIG. 1.

Noted on FIG. 1 is the presence of a return spring 19c effecting the return to its rearward position of the operating pin 15, and consequently of the stop pin 14.

In the position illustrated in FIG. 1, the fishing line is free to unreel or to be reeled in into the spool of the reel 3, the braking system on the reel being deactivated, that is in the unbraked position. When the fisherman pivots the pusher element 9 rearward, the head 9a pushes forward on the rear end 14a of the stop pin 14, causing it to slide longitudinally forward with respect to the guide member 16. Once the pusher element 9 is pivoted rearward, the return spring 19c effects a return of the rear end 14a of the stop pin 14 to a position of engagement. In this position of engagement, when the fisherman releases the pusher element, it tends to return automatically to the forward pivoted position; the head 9a of the pusher element 9 remains, however, in abutment against the rear end 14a of the stop pin 14, which is returned to its position of engagement.

In this position of engagement, the rear end 14a abutting the head 9a of the pusher element 9 prevents its return to the forward pivoted position, which keeps the cup 6 bearing against the underside 5a of the nosecone 5 and consequently effects the braking of the line 4. The fisherman can then proceed with the forward casting motion to project the line and the bait into the water. During the casting motion, the inertia of the flyweight 12 will act upon the wire element 13 and allow the operating pin 15, and consequently the stop pin 14, to slide longitudinally forward, which will allow the rear end 14a to disengage from the head 9a of the pusher element and thus allow it to pivot forward by automatic return, effecting the unbraking of the line 4 which can then be projected forward due to the inertia of the fishing line connected to its end.

This forward longitudinal sliding of the operating pin 15 and of the stop pin 14 is conditioned by the stiffness of the spring 19c. Preferably, the stop pin 14 and the operating pin consist of one and the same pin comprising a threaded portion on which is mounted a nut 20 illustrated in FIG. 1, the return spring 19c being set between this nut 20 and a part 16a of guide member 16. It is noted that the return spring 19c is compressed between the nut 20 and this part 16a of the guide member 16. An operation on the nut, that is a rotation of the nut, allows its position on the threaded portion arranged on the forward end area 14b of the stop pin 14 and the rear end 15a of the operating pin 15 to be altered, which allow its position to be changed longitudinally and thus to compress more or less the return spring 19c. This allows the spring load to be increased or decreased, and thus to adjust the triggering of the pusher element depending on the whipping force on the rod exerted by the fisherman during the casting motion.

According to the design variation of the casting fishing rod 1, illustrated in FIGS. 2 and 3, it is noted that the pusher element 8 is made up of an arm 17 extending longitudinally forward and of a pusher finger 18, which has its distal end 18a for example bearing on the rear end 7a of the translation pin 7 actuating the cup 6 so as to effect the braking of the fishing line.

The arm 17 and the pusher finger 18 are pivotably mounted on a pivoting axis 22 illustrated in FIGS. 2 and 3. It is noted that the arm 17 includes at its rear end 17b a control system 27 in the form of an control finger or button. Pressure exerted on this control system 27 makes it possible to effect a pivoting motion of the arm 17 and of the pusher finger 18 in which the forward end 17a of the arm 17 pivots upward and the distal end 18a of the pusher finger 18 pivots forward and presses on the rear end 7a of the translation pin 7. Conversely, release of the control system 27 allows the pusher element 8 to pivot in the opposite direction whereby the forward end 17a of the arm 17 is pivoted downward as illustrated in FIG. 2 and the distal end 18a of the pusher finger 18 is pivoted rearward, which allows rearward translation of the translation pin 7 whereby the cup 6 is disengaged from the nosecone 5. Of course, operation of the braking system of the reel 2, operating on the same principle, can be contemplated, by means of the pusher element 8.

The arm 17 and the pusher finger 18 can consist of one and the same member. However, as shown in FIGS. 2 and 3, the arm 17 and the pusher finger 18 consist of two members mounted so as to pivot with respect to each other about the pivoting axis 22. The presence of a spiral or helical spring 23 is noted in FIG. 2, arranged between the rear end 17b of the arm 17 and the proximal end 18b of the pusher finger 18. According to one variation, the presence of a torsion spring 21 is noted in FIG. 3, arranged between the rear end 17b of the arm 17 and the proximal end 18b of the pusher finger 18.

In both cases, when the control system 27 is actuated by the fisherman, which causes the arm 17 and the pusher finger 18 to pivot so as to effect the actuation of the braking system of the reel 2, said spiral spring 23 or said torsion spring 21 is compressed so as to effect a forward pivoting motion of the pusher finger 18 with respect to the arm 17, which makes it possible to effect a proper bearing of the distal end 18a of the pusher finger 18 against the rear end 7a of the translation pin 7 actuating the cup 6, or other variations of the braking system of the reel 2. Conversely, when the arm 17 and the pusher finger 18 are in a position in which the braking system is in an unbraked position, that is when the distal end 18a of the pusher finger 18 is rearwardly disengaged from the rear end 7a of the translation pin 7, said spiral spring 23 or said torsion spring 21 remains in the relaxed state in an inactive position. This system thus allows any play existing in the translation pin 7 effecting the movement of the cup 6, or other variations of the braking system of the reel 2, to be compensated.

Noted in FIGS. 2 and 3 is the presence of a stop system 10, which consists of a stop member 24. In FIGS. 2 and 3 it is noted that this stop member 24 is mounted on a pivot connection along a connection axis 25 allowing said stop member 24 to pivot rearward so as to make it bear against the forward end 17a of the arm 17 when it is pivoted upward. Conversely, a forward pivoting motion of the stop member 24 allows it to be disengaged from the forward end 17a of the arm 17, which allows it to return to a downward pivoted position and consequently allows a pivoted position of the pusher finger 18 that is disengaged from the braking system of the reel 2. A design variation of the stop member 24 could be contemplated allowing for slidable mounting of said member 24 allowing forward and rearward sliding thereof so as to allow it to bear or not against the forward end 17a of the arm 17.

It is noted in FIGS. 2 and 3 that the set of elements, that is the pusher element 8, the control system 27 and the stop system 10 are mounted on a support member 28, which is configured for attachment to the fishing rod 1.

Further noted on said FIGS. 2 and 3 is the presence of a flexible wire element 13, similar to that of FIG. 1, the rear end 13a whereof is affixed to the stop member 24 and the forward end 13 is affixed to the support member 28. In addition, the flyweight 12 is mounted on this flexible wire element 13.

Noted in FIG. 2 is the presence of a second torsion spring 19a arranged at the stop piece 24. Likewise noted in FIG. 3 is the presence of a second spiral spring 19b arranged between the stop member 24 and the support member 28. In both cases the torsion spring 19a and the spiral spring 19b have the function of effecting the return to the rearward position of the stop member 24.

Thus, when the fisherman wishes to proceed with the casting of the line into the water, he actuates the control system 27 which allows an upward pivoting motion of the arm 17 and the forward pivoting of the pusher finger 18, which then bears at its distal end 18a on the forward end 7a of the translation pin 7 and allows braking of the line 4 between the cup 6 and the underside 5a of the nosecone 5. In this position, the forward end 17a of the arm 17 is pivoted upward, which allows the torsion spring 19a or the spiral spring 19b to act upon the stop member 24 and to make it pivot rearward. Releasing the control system 27 tends to make the front end 17a of the arm 17 pivot downward, this end 17a bearing against the stop member 24 and consequently remaining blocked in that position, which ensures that the fishing line 4 braking position is maintained. The fisherman can then perform his casting motion during which the flyweight 12 will, by way of the flexible wire element 13 and due to its inertia, exert an action on the stop member 24 and make it pivot forward, which allows the disengagement said stop member 24 from the forward end 17a and allows its return to the downward pivoted position in which the pusher finger 18 pivots rearward and allow rearward translation of the translation pin 7, allowing the unbraking of the fishing line and consequently the projection of the fishing line into the water.

The rearward pivoting of the pusher element 8 is effected by the return spring arranged directly on the reel 2 and acting on the translation pin 7, which tends to translate rearward which allows the rear end 7a of this translation pin 7 to push on the distal end 18a of the pusher finger 18 and to make it pivot rearward due to the fact that the stop member 24 is disengaged from the end 17a of the arm 17, which also pivots downward. The torsion spring 19a or the spiral spring 19b tends to cause the stop member 24 to again pivot rearward and positions it against the forward end 17a of the arm 17 as illustrated in FIG. 2, while waiting to be able to pivot completely to the rear during a forthcoming operation of the control system 27.

The forward pivoting of the stop member 24 under the influence of the inertia of the flyweight 12 is conditioned by the stiffness of the torsion spring 19a or of the spiral spring 19b. In this regard, it is noted in FIG. 3 that the forward end 32 of the spiral spring 19b is mounted on a member 33 which is capable of pivoting with respect to the support member 28. The pivoting of member 33 allows the position of the forward end 32 of the spiral spring 19b to be altered, and thus to change the length of said spiral spring 19b. This allows the load exerted on the spring to be altered, and thus to adjust it according to the whipping force exerted by the fisherman during the casting motion so as to trigger the stop member 24 in a suitable position effecting optimization of the casting of the line. Similarly, a tensioning system can be provided on the torsion spring 19a by acting on the angular position of the branches 34, 35 of said torsion spring 19a.

Noted in FIGS. 2 and 3 is the presence of a locking/unlocking system 30. This locking/unlocking system 30 consists of a circular hole 30a provided on the stop member 24 and of a locking pin 30b mounted inside said circular hole 30a and pivotable about the connection axis 25 with respect to the support member 28. When this locking pin 30b is pivoted upward as illustrated in FIG. 3, it allows rearward pivoting of the stop member 24. Conversely, when this locking pin 30b is pivoted downward as illustrated in FIG. 2, the hole 30a bears against said locking pin 30b, preventing the rearward pivoting of the stop member 24. This has the advantage of disabling the stop member 24 and allowing the control system 27 and the pusher element 8 to be used as in a traditional “closed end” reel.

According to this second design variation of the casting fishing rod 1 illustrated in FIGS. 2 and 3, variations in implementing the stop system 10 can be contemplated, as illustrated for example in FIG. 4. In said FIG. 4 the presence of a flexible blade 26 is noted, the proximal end 26a whereof is affixed to the support member 28 and the distal end 26b whereof is capable of bearing on the forward end 17a of the arm 17. In addition, the rear end 13a of the flexible wire element 13 is affixed to said distal end 26b. Said blade 26 is capable of bending under the influence of the inertia of the flyweight 12, which allows its disengagement from the forward end 17a of the arm 17 so as to allow it to pivot downward. Conversely, during actuation of the pusher element 8 under the influence of the control system 27, the forward end 17a of the arm 17 pivots upward which makes it possible, due to the flexibility of the blade 26, to allow the distal end 26b of said blade 26 to bear against said forward end 17a of the arm 17.

Preferably and without limitation, the flexible wire element 13 is made of an injection-molded material such as an elastomer for example. However, its design based on other materials, such as textile materials, can be contemplated.

The foregoing description of the two preferred embodiments of a casting fishing rod is not limiting. In particular, a locking/unlocking system 30 on the casting fishing rod illustrated in FIG. 1 can be contemplated according to the first variation so as to block the stop pin in a longitudinally forward slipped position into a position that is disengaged from the head 9a of the pusher element 9.

Variations can be contemplated having designs of the braking system on the reel other than that described in the above implementation examples, and operating on the same principle.

1. A casting type fishing rod including a reel on which is wound some fishing line, the reel including a fishing line braking system configured, in a braking position, to hold the fishing line and, in an non-braking position, to release the fishing line, wherein the casting fishing rod includes:
a pusher element configured to be moved into a first position in which said pusher element activates the braking system in the braking position and into a second position in which said pusher element allows the braking system to return to the non-braking position;
a stop system on the pusher element configured to, in a position of engagement, hold said pusher element in the first position and, in a position of disengagement, to release the pusher element so as to allow its return to the second position; and
an inertia flyweight affixed to a flexible wire element, whereof a first end is affixed to the stop system and a second end is affixed to the fishing rod, the inertia of the flyweight allowing movement of the stop system into the position of disengagement.

2. A casting fishing rod according to claim 1, the pusher element being mounted directly on the reel and provided with a head, the stop system consisting of a stop pin and an actuating pin mounted for longitudinal translation on a fishing rod, the stop pin including a rear end forming a stop on the head of the pusher element moved into its first position and a forward end affixed to a rear end of the actuating pin, said actuating pin having a forward end affixed to the first end of the flexible wire element.

3. A casting fishing rod according to claim 2, a guide member being configured to receive the stop pin and the actuating pin so that they slide along their longitudinal axes, said guide member being configured to be affixed to the fishing rod.

4. A casting fishing rod according to claim 2, the pusher element being pivotably mounted so as to move into the first position or into the second position, the braking system of the reel being configured to reposition said pusher element into the second position when the stop system is in the position of disengagement.

5. A casting fishing rod according to claim 1, the pusher element comprising an arm and a pusher finger, said arm and finger being pivotably mounted on the fishing rod, the stop system being configured to hold, in the position of engagement, a forward end of the arm in an upward pivoted position in which the pusher finger acts on the braking system of the fishing line to hold it in the braking position.

6. A casting fishing rod according to claim 1, the stop system including return means configured to effect the movement of said stop system into the position of engagement upon movement of the pusher element to the first position.

7. A casting fishing rod according to claim 1, including a tensioning system configured to alter the triggering sensitivity of the stop system under the influence of the inertia of the flyweight.

8. A casting fishing rod according to claim 1, including a compensation system configured to take up the existing play in the braking system and guarantee the holding of the fishing line when said braking system is in the braking position and the pusher element is in the first position.

9. A casting fishing rod according to claim 5, the arm and the pusher finger being pivot mounted with respect to one another, a return member being provided between said arm and the pusher finger to, in the first position, exert a force on the pusher finger and guarantee that said pusher finger correctly activates the braking system of the fishing line so as to hold it in the braking position.

10. A casting fishing rod according to claim 5, the stop system including a stop member configured to move rearward into a position holding the forward end of the arm in an upward pivoted position and to move forward, under the influence of the flyweight, into a position disengaged from the forward end of the arm, allowing the pusher element to return to the second position, a return element being configured to exert a force on the stop member so as to move said stop member rearward.

11. A casting fishing rod according to claim 10, the stop member being pivot mounted with respect to the fishing rod, the return element being a spring or an elastic.

12. A casting fishing rod according to claim 10, the stop member and the return element consisting concomitantly of a flexible blade, whereof a first end is fixed with respect to the fishing rod and a second end allows the forward end of the arm to be held in an upward pivoted position.

13. A casting fishing rod according to claim 5, the arm including at its rear end a control system configured to actuate the pusher element in the first position.

14. A casting fishing rod according to claim 1, including a locking/unlocking system for the stop system configured to allow manual use of the pusher element.

15. A casting fishing rod according to claim 1, including a support member configured to be affixed to said fishing rod and to receive the pusher element and the stop system.

16. A casting fishing rod according to claim 1, including a holding member configured to be attached to the fishing rod, attachment means being provided between the forward end of the flexible wire element and said holding member.

17. A casting fishing rod according to claim 1, the flexible wire element being made of an injection-molded material.
